(19) United States
(12) Patent Application Publication
(10) Pub. No.: US 2022/0082223 A1
(43) Pub. Date: Mar. 17, 2022

(54) SPOTLIGHT STRUCTURE

(71) Applicant: JIANGSU COMFORT LIGHTING CO., LTD., Yancheng (CN)

(72) Inventors: Haicheng ZHANG, Nanjing (CN); Honggui XIE, Nanjing (CN); Zhengen LI, Heze (CN)

(73) Assignee: JIANGSU COMFORT LIGHTING CO., LTD., Yancheng (CN)

(21) Appl. No.: 16/969,968

(22) PCT Filed: Apr. 30, 2020
(86) PCT No.: PCT/CN2020/088127

§ 371 Date: Aug. 13, 2020

(30) Foreign Application Priority Data
Apr. 23, 2020 (CN) 202010325182.5

(51) Int. Cl. F21S 8/08; B08B 3/02; B08B 13/00; B08B 1/04; F21V 31/00

(52) U.S. Cl. CPC F21S 8/081; B08B 3/02; F21Y 2115/10; B08B 1/04; F21V 31/005; B08B 13/00

(57) ABSTRACT

A spotlight structure includes a main body, a waterproof front cover, and a waterproof rear cover. A front cavity and a rear cavity are arranged in the main body. A focusing component, a spotlight adjusting component and a color temperature adjusting component are arranged in the cavities. A screw thread is arranged on the outer walls of the front end and the rear end of the main body. A dovetail groove is arranged at the root of the screw thread. An O-ring is arranged on the dovetail groove. An edge of the waterproof front cover adjacent to the O-ring and an edge of the waterproof rear cover adjacent to the O-ring are a beveled edge, respectively. The waterproof front cover is threaded with the front end of the main body, and the waterproof rear cover is threaded with the rear end of the main body.

### TECHNICAL FIELD

The present invention belongs to the technical field of light-emitting diode (LED) light, and more specifically, relates to a spotlight structure.

### BACKGROUND

An outdoor spotlight is typically used to draw attention to key areas of outdoor building structures and landscaping, including trees, plants, architectural signs, artificial mountains, stones, signage and the like. In the key outdoor areas to be highlighted, the features of different objects be lit using spotlights of different sizes, different color temperatures and different brightness. Different object sizes, shapes and areas of emphasis also influence the selection of spotlight features. Current spotlights typically have an adjusting device on the outer wall. Such exterior structures, however, are usually not water resistant. As a result, rainwater often seeps into the spotlights and causes lighting failure. It is, therefore, highly desirable to design an outdoor spotlight that is waterproof, brightness-adjustable, has color temperature-adjustable and spot size-adjustable.

### SUMMARY

The technical problem to be solved by the present invention is that the brightness-adjustable, color-adjustable and spot-adjustable spotlights in the prior art have poor water resistance and water may easily seep therein.

The present invention adopts the following technical solution. A spotlight structure includes a main body, a waterproof front cover and a waterproof rear cover. Screw threads are arranged on the outer wall of the front end of the main body and the outer wall of the rear end of the main body, and a dovetail groove is arranged at the root of the screw thread. An O-ring is sleeved on the dovetail groove. An edge of the waterproof front cover next to the O-ring and an edge of the waterproof rear cover next to the O-ring are a beveled edge, respectively. The waterproof front cover is connected to the front end of the main body by the screw thread, and the waterproof rear cover is connected to the rear end of the main body by the screw thread.

Preferably, a brightness adjusting component, a color temperature adjusting component, and a spotlight adjusting component are built into the front cavity and the rear cavity of the main body. The front end and the rear end of the main body are respectively provided with a screw tooth, and the front cover and the rear cover are connected to the main body by the spiral structure. A rubber gasket is compressed to seal the front cavity and the rear cavity of the main body, respectively. When the cover is unscrewed, users can easily adjust the brightness, color temperature, and spotlight size. When the cover is securely screwed into place, the three components are hermetically enclosed in the waterproof main body.

Preferably, the outer wall of the front cover and the outer wall of the rear cover are provided with a knurling, respectively.

An oblique-opening cover is arranged on one end of the front cover and one end of the rear end, respectively.

The other end of the front cover is provided with a U-shaped groove near the edge. A transparent body is stuck to the front cover by filling an adhesive in the U-shaped groove.

The other end of the rear cover is sealed and is shaped as a bowl-shaped housing.

Preferably, the main body is provided with an inner cavity. A bulkhead is arranged in the inner cavity, and the bulkhead divides the inner cavity into the front cavity and the rear cavity. A spotlight adjusting component is arranged in the front cavity, and a color adjusting component is arranged in the rear cavity.

Preferably, the spotlight adjusting component includes:

a light source bracket, wherein, the light source bracket is fixed to the bottom wall of the front cavity by the screw, the light source bracket presses a luminous body against the bottom wall of the front cavity; three lug bosses are arranged on the light source bracket in a circumferential direction, and a convex rib is arranged at an upper portion and a lower portion of each lug boss;

a lens holder, wherein, three oblique grooves are circumferentially arranged on the outer wall of the lens holder, and convex ribs are evenly distributed on the upper and lower sides of the oblique grooves; the lug boss is engaged into the oblique groove; a lens is installed on the lens holder; a honeycomb net and a color filter are successively placed on the top of the lens; and a rotating cylinder, wherein, the rotating cylinder is engaged into the lens holder.

Preferably, the color adjusting component includes:

a plastic power supply box, wherein, the plastic power supply box is fixed on the inner wall of the rear cavity by a screw; one end of the plastic power supply box is provided with an intelligent control power supply, and two electronic leads of the luminous body are connected to the output terminal of the intelligent control power supply;

a square groove, wherein, the square groove is arranged on the side wall of the main body; a waist-shaped hole and a threaded hole are arranged on the bottom of the square groove; an adapter block is arranged in the square groove, and the adapter block is fixed in the square groove by a bolt; and

a rotating arm, wherein, one end of the rotating arm is engaged with the adapter block, the other end of the rotating arm is provided with a screw thread, and the rotating arm can be fixedly connected to a fixed base by the screw thread; the input lead of the intelligent control power supply passes out of the side wall of the main body, successively through the adapter block and the rotating arm, and is then connected to a wire.

Preferably, a dimming button and a color temperature adjusting button are arranged on the intelligent control power supply, respectively.

Preferably, the outer wall of the front cover and the outer wall of the rear cover are provided with the knurling.

Preferably, the oblique-opening cover is arranged on one end of the front cover and one end of the rear cover.

The other end of the front cover is provided with the U-shaped groove near the edge. The transparent body is stuck to the front cover by filling the adhesive in the U-shaped groove.

The other end of the rear cover is sealed and is shaped as the bowl-shaped housing.

Preferably, a cleaning device is arranged on the outer wall of the main body, and the cleaning device includes:

a housing, wherein, the housing is arranged on the outer wall of the main body, and the housing is shaped as a cylinder, the side wall of the housing is provided with an annular opening;

a bearing, wherein, the bearing is arranged in the housing, and the inner ring of the bearing is fixed to the outer wall of the main body;

a first bevel gear, wherein, a first through hole is arranged at the center of the first bevel gear, the inner wall of the first through hole is fixedly connected to the outer ring of the bearing, and the first bevel gear is rotated around the axis of the main body;

a sliding groove, wherein the sliding groove is arranged on the side wall of the first bevel gear; the sliding groove extends in the radial direction of the first bevel gear; a sliding block is arranged in the sliding groove, and the sliding block can move back and forth along the sliding groove; an engaged strip is arranged on the side wall of the sliding block; the inner wall of the sliding groove is provided with a guide groove, and the engaged strip is engaged into the guide groove;

a guide rod, wherein, the guide rod is arranged under the sliding groove; one end of the guide rod is connected to the side wall of the first bevel gear, and the other end of the guide rod passes through the annular opening and extends out of the housing;

a cleaning ring, wherein, the cleaning ring is sleeved on the outer wall of the main body; the side wall of the cleaning ring is provided with a second through hole extending in the axial direction; the end of the guide rod away from the first bevel gear passes through the second through hole and is connected to a stop block; a bristle is arranged on the inner wall of the cleaning ring;

a spring, wherein, the spring is sleeved on the guide rod; one end of the spring is connected to the side wall of the first bevel gear, and the other end of the spring is connected to the cleaning ring; and a connecting rod, wherein, one end of the connecting rod is hinged to the sliding block, and the other end of the connecting rod is hinged to the outer wall of the cleaning ring.

Preferably, the cleaning device further includes a motor, wherein, the motor is arranged on the outer wall of the main body. The motor (46) is located in the housing, and the output shaft of the motor extends outwards and is connected to a second bevel gear. The first bevel gear is engaged with the second bevel gear.

Preferably, a cleaning solution spraying device is further provided, and the cleaning solution spraying device includes:

a fluid storage tank, wherein, the fluid storage tank is arranged at the upper end of the housing, and a cleaning solution is provided in the fluid storage tank;

a plurality of third through holes, wherein, the plurality of third through holes are provided on the outer wall of the main body in the circumferential direction, and the cleaning ring covers on the third through hole;

a spray head, wherein, the spray head is arranged on the stop block, and the nozzle of the spray head faces toward the third through hole;

a connecting pipe, wherein, one end of the connecting pipe is connected to the bottom of the fluid storage tank, and the other end of the connecting pipe is connected to the spray head; a pressure pump and a solenoid valve are successively arranged on the connecting pipe; a processor is arranged in the housing, and the processor is connected to the motor, the pressure pump and the solenoid valve, respectively; the processor is wirelessly communicated with a mobile terminal; and a fluid intake pipe, wherein the fluid intake pipe is arranged on the top of the fluid storage tank, and a cover is arranged on the upper end of the fluid intake pipe.

The present invention has the following advantages. A spotlight structure includes a main body, a waterproof front cover, and a waterproof rear cover. A screw thread is arranged on the outer wall of the front end of the main body and the outer wall of the rear end of the main body, and a dovetail groove is arranged at the root of the screw thread. An O-ring is sleeved on the dovetail groove. The edge of the waterproof front cover next to the O-ring and the edge of the waterproof rear cover next to the O-ring are a beveled edge, respectively. The waterproof front cover is threaded with the front end of the main body, and the waterproof rear cover is threaded with the rear end of the main body. When the rotating cylinder, the dimming button, and the color temperature adjusting button are not adjusted, they are sealed by the waterproof front cover and the waterproof rear cover. Therefore, water seepage into the inner cavities is prevented thus improving the service life of the spotlight.

The other features and advantages of the present invention will be described subsequently in conjunction with the embodiments, and become partially clear, or be understood by the implementation of the present invention. The purpose and other advantages of the present invention can be implemented and obtained by the structure specified in the description and the drawings.

The technical solution of the present invention is further described in detail hereinafter with reference to the drawings and the embodiments.

### BRIEF DESCRIPTION OF THE DRAWINGS

The drawings are used to provide a further understanding of the present invention and form part of the specification, and the drawings are used together with the embodiments of the present invention to describe the present invention but do not constitute a limitation to the present invention. In the drawings:

FIG. 1 is a schematic diagram showing the structure of the present invention.

FIG. 2 is a schematic diagram showing the structure of a main body of the present invention.

FIG. 3 is a schematic diagram showing the structure of a square groove of the present invention.

FIG. 4 is a schematic diagram showing the external of a waterproof front cover in the present invention.

FIG. 5 is a schematic diagram showing the interior structure of the waterproof front cover in the present invention.

FIG. 6 is a schematic diagram showing the external of a waterproof rear cover in the present invention.

FIG. 7 is a schematic diagram showing the interior structure of the waterproof rear cover in the present invention.

FIG. 8 is a schematic diagram showing the structures of a dimming button and a color temperature adjusting button in the present invention.

FIG. 9 is a schematic diagram showing the structure of a cleaning device in the present invention.

FIG. 10 is a schematic diagram showing the structure of a first bevel gear in the present invention.

FIG. 11 is a schematic diagram showing the structure of a cleaning ring in the present invention.

In the figures: 1—main body, 2—screw thread, 3—dovetail groove, 4—waterproof front cover, 5—waterproof rear cover, 6—bulkhead, 7—front cavity, 8—rear cavity, 9—light source bracket, 10—lens holder, 11—lens, 12—color filter, 13—rotating cylinder, 14—plastic power supply box, 15—intelligent control power supply, 16—square groove, 17—waist—shaped hole, 18—threaded hole, 19—adapter block, 20—rotating arm, 21—wire, 22—dimming button, 23—color temperature adjusting button, 24—knurling, 25—oblique—opening cover, 26—O—shaped ring, 27—oblique edge, 28—honeycomb net, 29—lug boss, 30—oblique groove, 31—transparent body, 32—housing, 33—bearing, 34—first bevel gear, 35—sliding groove, 36—sliding block, 37—annular opening, 38—guide rod, 39—cleaning ring, 40—second through hole, 41—stop block, 42—spring, 43—connecting rod, 44—engaged strip, 45—guide groove, 46—motor, 47—second bevel gear, 48—fluid storage tank, 49—third through hole, 50—spray head, 51—connecting pipe, 52—pressure pump, 53—solenoid valve, 54—processor, 55—fluid intake pipe, 56—cover.

### DETAILED DESCRIPTION OF THE EMBODIMENTS

The preferred embodiments of the present invention are described hereinafter in conjunction with the drawings, it should be noted that the preferred embodiments described herein are only for the purpose of illustration and interpretation of the present invention and shall not limit the present invention.

The embodiment of the present invention provides a spotlight structure, including the main body 1, the waterproof front cover 4, and the waterproof rear cover 5. The screw thread 2 is arranged on the outer wall of the front end of the main body 1 and the outer wall of the rear end of the main body 1. The dovetail groove 3 is arranged at the root of the screw thread 2 and the O-ring 26 is sleeved on the dovetail groove 3. The edge of the waterproof front cover 4 adjacent to the O-ring 26 and the edge of the waterproof rear cover 5 adjacent to the O-ring 26 are the beveled edge 27, respectively. The waterproof front cover 4 is threaded with the front end of the main body 1, and the waterproof rear cover 5 is threaded with the rear end of the main body 1. The waterproof front cover 4 and the waterproof rear cover 5 are bowl-shaped.

The principle and advantages of the above technical solution are as follows. The waterproof front cover 4 and the waterproof rear cover 5 are respectively installed on the front end and the rear end of the main body 1 by means of the screw thread 2. During the screwing process, the waterproof rear cover 5 causes the O-ring 26 to squeeze inward along the dovetail groove 3 of the main body 1, to form a water-tight seal at the rear end. Since the edge of one end of the waterproof front cover 4 is the beveled edge 27, during the screwing process, the waterproof front cover 4 causes the O-ring to squeeze inward along the dovetail groove 3 of the main body 1 to achieve a waterproof seal at the front end.

In an embodiment, the main body 1 is provided with the inner cavity, and the bulkhead 6 is arranged in the inner cavity. The bulkhead 6 divides the inner cavity into the front cavity 7 and the rear cavity 8. The spotlight adjusting component is arranged in the front cavity 7, and the color adjusting component is arranged in the rear cavity 8.

The spotlight adjusting component includes:

the light source bracket 9, wherein the light source bracket 9 is fixed to the bottom wall of the front cavity 7 by the screw, the light source bracket 9 presses the luminous body against the bottom wall of the front cavity 7, three lug bosses 29 are arranged on the light source bracket 9 in the circumferential direction;

the lens holder 10, wherein, three oblique grooves 30 are arranged on the outer wall of the lens holder 10 in the circumferential direction; the lug boss 29 is engaged into the oblique groove 30; the lens 11 is installed on the lens holder 10; the honeycomb net 28 and the color filter 12 are placed on the top of the lens 11 in sequence; the lens holder is provided with the upwardly tilted waist-shaped sliding grooves; the convex rib is arranged in the sliding groove to increase the damping during rotation, making the operation better; and the rotating cylinder 13, wherein the rotating cylinder 13 is engaged into the lens holder 10.

The color adjusting component includes:

the plastic power supply box 14, wherein, the plastic power supply box 14 is fixed on the inner wall of the rear cavity 8 by the screw; one end of the plastic power supply box 14 is provided with the intelligent control power supply 15, and two electronic leads of the luminous body are connected to the output terminal of the intelligent control power supply 15;

the square groove 16, wherein the square groove 16 is arranged on the side wall of the main body 1; the waist-shaped hole 17 and the threaded hole 18 are arranged on the bottom of the square groove 16; the adapter block 19 is arranged in the square groove 16; the adapter block 19 is fixed in the square groove 16 by the bolt; and

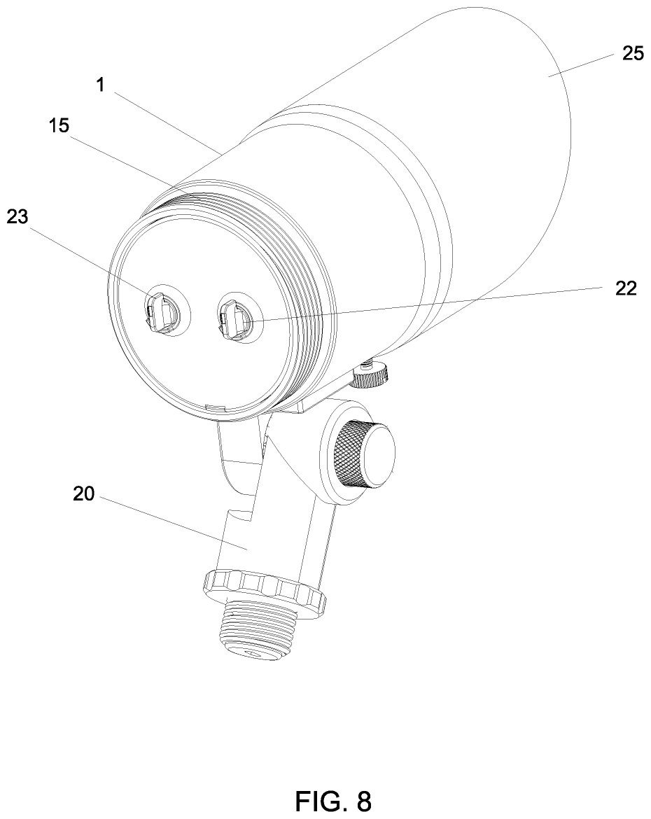

the rotating arm 20, wherein, one end of the rotating arm 20 is engaged with the adapter block 19, the other end of the rotating arm 20 is provided with the screw thread, and the rotating arm 20 can be fixedly connected to the fixed base by the screw thread; the input lead of the intelligent control power supply 15 passes out of the side wall of the main body 1, successively through the adapter block 19 and the rotating arm 20, and is then connected to the wire 21; as shown in FIG. 8, the intelligent control power supply 15 is provided with the dimming button 22 and the color temperature adjusting button 23, respectively; the control power supply is fixed to the plastic power supply box by the screw, and the rotating arm is fixed to the adapter block by the screw, and then the mixed AB adhesive is filled into the power supply box. The adhesive is filled in the main body, the power supply box and the intelligent control power supply, and seals the outlet hole in waterproof fashion.

The principle and advantages of the above technical solution are as follows. When the size of the spotlight needs to be adjusted, the waterproof front cover 4 is unscrewed, the rotating cylinder 13 is manually rotated to turn the lens holder 10 and the lens 11. The lug boss 29 moves along the oblique groove 30, so that the rotating cylinder 13 rotates clockwise and the lens 11 moves away from the luminous body, thereby decreasing the size of the spotlight; when the rotating cylinder 13 rotates clockwise, the lens 11 moves closer to the luminous body, thereby increasing the size of the spotlight. After the adjustment of the spotlight, the waterproof front cover 4 is screwed so that the O-ring is pressed into the dovetail groove of the main body 1 to achieve sealing, thereby preventing water from entering the cavity. During rotation, the convex rib on the lug boss 29 and the convex rib on the oblique groove 30 create a damping effect on each other, making the angle adjustment tactile. When the brightness and the color temperature need to be adjusted, the waterproof rear cover 5 is unscrewed, the dimming button 22 is rotated to adjust the brightness, and the color temperature adjusting button 23 is rotated to adjust the color temperature. After adjustment, the waterproof rear cover 5 is screwed so that the O-ring is pressed into the dovetail groove of the main body 1 to form a waterproof seal preventing water from entering the cavity. The rotating cylinder, the dimming button and the color temperature adjusting button, when not adjusted, are sealed by the waterproof front cover and the waterproof rear cover. Therefore, it is not easy to contact with water to cause failure, thereby improving the service life of the spotlight.

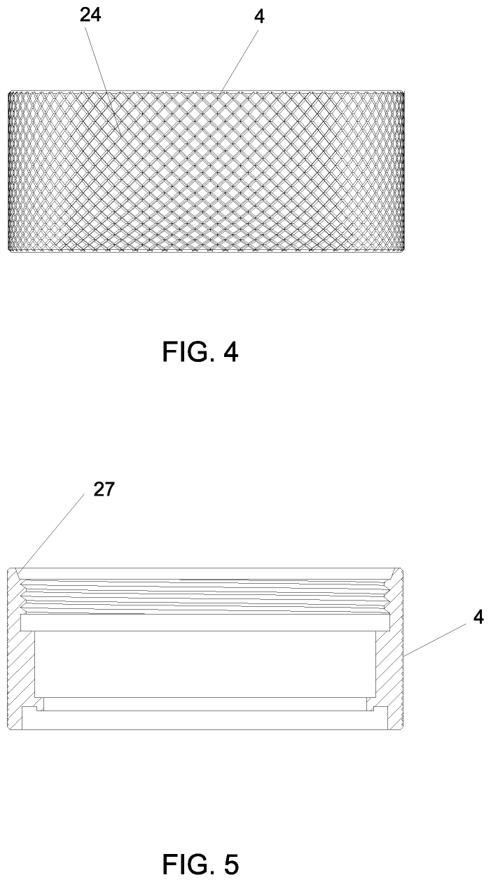

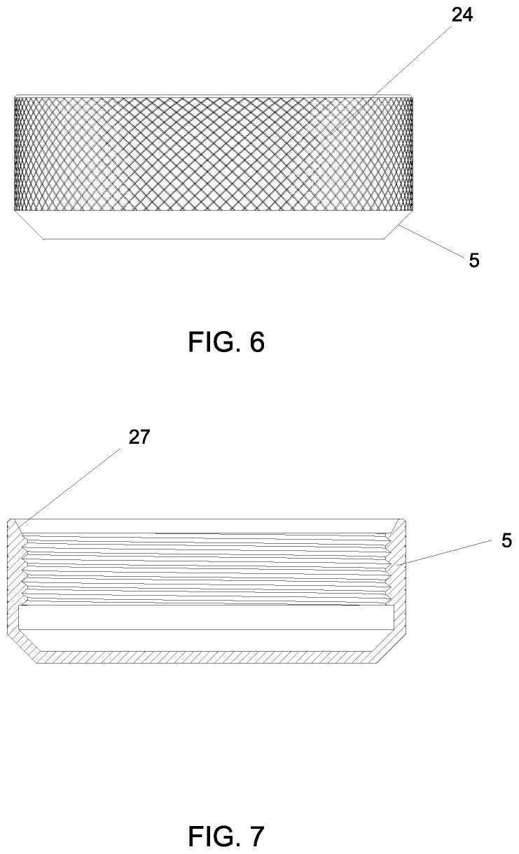

In an embodiment, as shown in FIGS. 4-7, the outer wall of the waterproof front cover 4 and the outer wall of the waterproof rear cover 5 are provided with the knurling 24.

The principle and advantage of the above technical solution are as follows. The knurling 24 arranged on the external surface increases friction, facilitating disassembly and assembly.

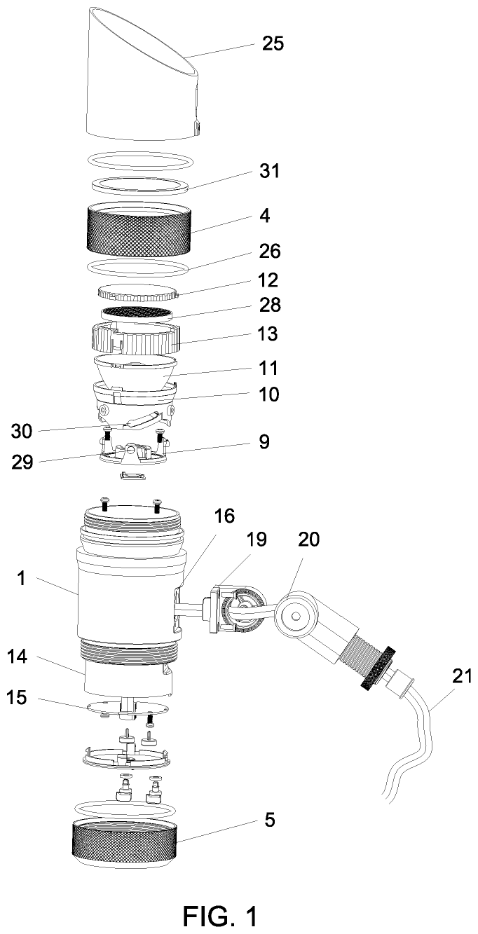

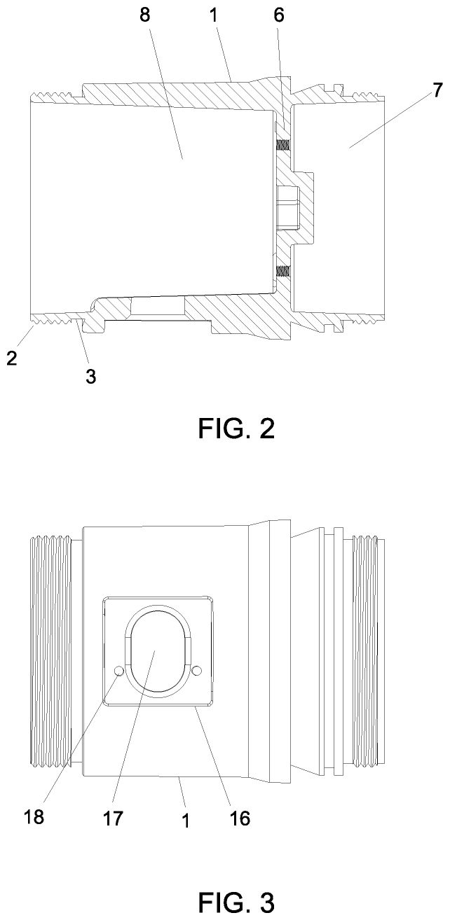

In an embodiment, as shown in FIG. 1, the oblique-opening cover 25 is arranged on the waterproof front cover 4.

The principle and advantage of the above technical solution are follows. The oblique-opening cover 25 is sleeved on the front end of the spotlight to adjust the projection direction of the light. The bottom of the oblique-opening cover 25 is provided with the screw tooth and is fixed by the screw manually. The transparent body 31 is arranged between the oblique-opening cover 25 and the waterproof front cover 4, and the transparent body 31 is made of glass.

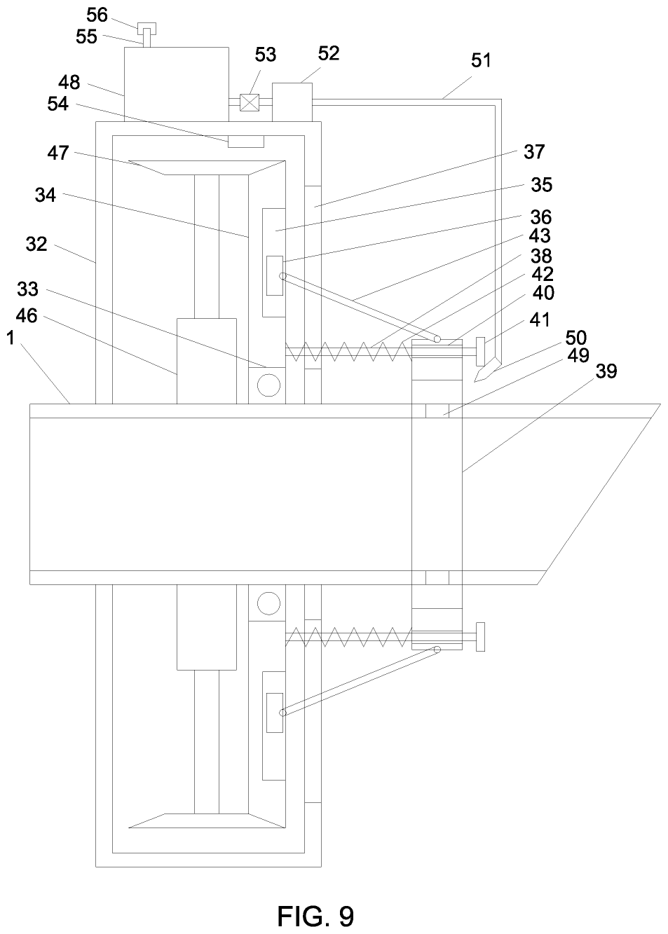

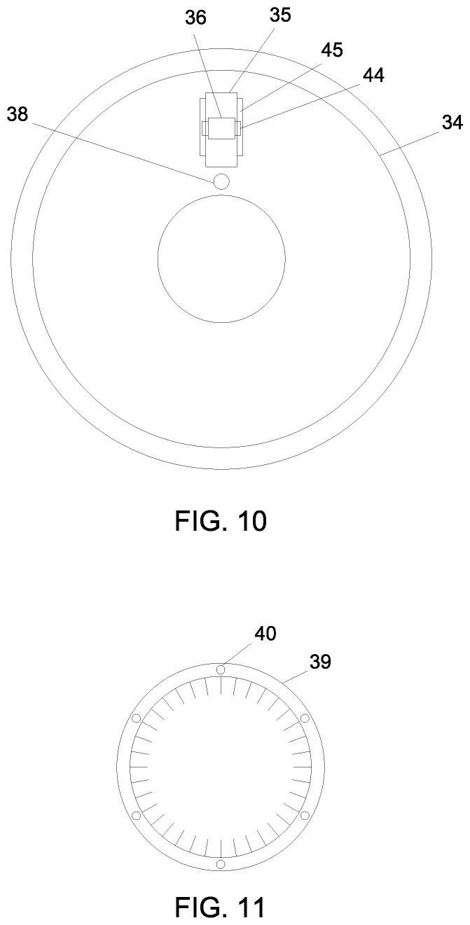

In an embodiment, as shown in FIGS. 9-11, the cleaning device is arranged on the outer wall of the main body 1. The cleaning device includes:

the housing 32, wherein the housing 32 is arranged on the outer wall of the main body 1, and the housing 32 is shaped as a cylinder, and the side wall of the housing 32 is provided with the annular opening 37;

the bearing 33, wherein the bearing 33 is arranged in the housing 32, and the inner ring of the bearing 33 is fixed to the outer wall of the main body 1;

the first bevel gear 34, wherein a first through hole is arranged at the center of the first bevel gear 34, the inner wall of the first through hole is fixedly connected to the outer ring of the bearing 33, and the first bevel gear 34 can rotate around the axis of the main body 1;

the sliding groove 35, wherein, the sliding groove 35 is arranged on the side wall of the first bevel gear 34; the sliding groove 35 extends in the radial direction of the first bevel gear 34; the sliding block 36 is arranged in the sliding groove 35, and the sliding block 36 can move back and forth along the sliding groove 35; the engaged strip 44 is arranged at the side wall of the sliding block 36; the guide groove 45 is arranged at the inner wall of the sliding groove 35, and the engaged strip 44 is engaged into the guide groove 45;

the guide rod 38, wherein the guide rod 38 is arranged under the sliding groove 35; one end of the guide rod 38 is connected to the side wall of the first bevel gear 34, and the other end of the guide rod 38 passes through the annular opening 37 and extends out of the housing 32;

the cleaning ring 39, wherein the cleaning ring 39 is sleeved on the outer wall of the main body 1; the side wall of the cleaning ring 39 is provided with the second through hole 40 extending in the axial direction; the end of the guide rod 38 away from the first bevel gear 34 passes through the second through hole 40 and is connected to the stop block 41; the bristle is arranged on the inner wall of the cleaning ring 39;

the spring 42, wherein the spring 42 is sleeved on the guide rod 38; one end of the spring 42 is connected to the side wall of the first bevel gear 34, and the other end of the spring 42 is connected to the cleaning ring 39; and the connecting rod 43, wherein one end of the connecting rod 43 is hinged to the sliding block 36, and the other end of the connecting rod 43 is hinged to the outer wall of the cleaning ring 39.

The cleaning device further includes the motor 46, wherein the motor 46 is arranged on the outer wall of the main body 1. The motor 46 is located in the housing 32, and the output shaft of the motor 46 extends outwards and is connected to the second bevel gear 47. The first bevel gear 34 is engaged with the second bevel gear 47.

The principle and advantage of the above technical solution are as follows. When the outer wall of the spotlight needs to be cleaned, the motor 46 is activated to drive the second bevel gear 47 to rotate. Since the second bevel gear 47 is engaged with the first bevel gear 34, the second bevel gear 47 drives the first bevel gear 34 to rotate, and the sliding block 36 moves toward the outside of the sliding groove 35 under the action of the centrifugal force. Therefore, the connecting rod 43 drives the cleaning ring 39 to move left along the guide rod 38, and compress the spring 42. The centrifugal force is changed by the rotating speed of the motor 46, and thus the balance position of the cleaning ring 39 changes, and the cleaning ring 39 moves back and forth, right and left. Meanwhile, the cleaning ring 39 keeps rotating, so that the bristle on the inner wall of the cleaning ring 39 cleans the outer wall of the main body 1, removing dust from the outer wall of the main body 1.

In an embodiment, a cleaning solution spraying device is further provided. The cleaning solution spraying device includes:

the fluid storage tank 48, wherein, the fluid storage tank 48 is arranged at the upper end of the housing 32, and the cleaning solution is provided in the fluid storage tank 48;

a plurality of third through holes 49, wherein, the plurality of third through holes 49 are provided on the outer wall of the main body 1 in the circumferential direction, and the cleaning ring 39 covers on the third through hole 49;

the spray head 50, wherein, the spray head 50 is arranged on the stop block 41, and the nozzle of the spray head 50 faces toward the third through hole 49;

the connecting pipe 51, wherein, one end of the connecting pipe 51 is connected to the bottom of the fluid storage tank 48, and the other end of the connecting pipe 51 is connected to the spray head 50; the pressure pump 52 and the solenoid valve 53 are successively arranged on the connecting pipe 51; the processor 54 is arranged in the housing 32, and the the processor 54 is connected to the motor 46, the pressure pump 52 and the solenoid valve 53, respectively; the processor 54 is wirelessly communicated with the mobile terminal, and the mobile terminal is a mobile phone; and the fluid intake pipe 55, wherein, the fluid intake pipe 55 is arranged on the top of the fluid storage tank 48, and the cover 56 is arranged on the upper end of the fluid intake pipe 55.

The principle and advantage of the above technical solution area follows. During the cleaning process, the motor 46, the pressure pump 52 and the solenoid valve 53 are activated by the mobile phone, and the cleaning solution in the fluid storage tank 48 is delivered to the spray head 50 via the connecting pipe 51. When the cleaning ring 39 moves to the left end, the cleaning solution is sprayed onto the bristle, then the cleaning ring 39 moves to the right end to brush the outer wall of the main body 1. After the cleaning ring 39 moves away from the third through hole 49, the cleaning solution can be sprayed into the main body 1 via the third through hole 49 to wash and clean the transparent body 31 in the main body 1, thereby removing dust or dirt from the glass surface and avoiding affecting the brightness of the spotlight. When the cleaning device is stopped, the cleaning ring 39 is pushed to the left end under the elastic force of the spring 42, and the cleaning ring 39 covers the surface of the third through hole 49 to achieve sealing, preventing the entry of rainwater and dust.

Obviously, modifications and variations to the present invention can be made by those skilled in the art without departing from the spirit and scope of the present invention. Thus, if the modifications and variations of invention belong to the scope of the claims and the same technology of the present invention, such modifications and variations shall fall within the present invention

What is claimed is:

1. A spotlight structure, comprising a main body, a waterproof front cover and a waterproof rear cover, wherein a screw thread is provided on an outer wall of a front end of the main body and an outer wall of a rear end of the main body; a dovetail groove is arranged at a root of the screw thread; an O-shaped ring is sleeved on the dovetail groove; an edge of the waterproof front cover adjacent to the O-shaped ring is a first beveled edge and an edge of the waterproof rear cover adjacent to the O-shaped ring is a second beveled edge; the waterproof front cover is threaded with the front end of the main body, and the waterproof rear cover is threaded with the rear end of the main body.

2. The spotlight structure according to claim 1, wherein, the main body is provided with an inner cavity, and a bulkhead is arranged in the inner cavity, and the bulkhead divides the inner cavity into a front cavity and a rear cavity; a light spot adjusting component is arranged in the front cavity, and a color temperature adjusting component is arranged in the rear cavity.

3. The spotlight structure according to claim 2, wherein, the light spot adjusting component comprises:
a light source bracket, wherein, the light source bracket is fixed to a bottom wall of the front cavity by a first screw; the light source bracket presses a luminous body against the bottom wall of the front cavity; three lug bosses are arranged on the light source bracket in a circumferential direction of the light source bracket;
a lens holder, wherein, three oblique grooves are arranged on an outer wall of the lens holder in a circumferential direction of the lens holder; the three lug bosses are engaged into the three oblique grooves; a lens is installed on the lens holder; a honeycomb net and a color filter are successively placed on a top of the lens; and
a rotating cylinder, wherein, the rotating cylinder is engaged into the lens holder.

4. The spotlight structure according to claim 3, wherein, the color temperature adjusting component comprises:
a plastic power supply box, wherein, the plastic power supply box is fixed on an inner wall of the rear cavity by a second screw; one end of the plastic power supply box is provided with an intelligent control power supply, and two electronic leads of the luminous body are connected to an output terminal of the intelligent control power supply;
a square groove, wherein, the square groove is arranged on a side wall of the main body; a waist-shaped hole and a threaded hole are arranged on a bottom of the square groove; an adapter block is arranged in the square groove, and the adapter block is fixed in the square groove by a bolt; and
a rotating arm, wherein, a first end of the rotating arm is engaged with the adapter block, and a second end of the the rotating arm is provided with a screw thread, and the rotating arm is fixedly connected to a fixed base by the screw thread; an input lead of the intelligent control power supply passes out of the side wall of the main body, successively through the adapter block and the rotating arm secondly, and is then connected to a wire, the rotating arm is fixed to the adapter block by a third screw, and then an adhesive is filled into the main body for a sealing.

5. The spotlight structure according to claim 4, wherein, a dimming button and a color temperature adjusting button are arranged on the intelligent control power supply.

6. The spotlight structure according to claim 1, wherein, an outer wall of the waterproof front cover is provided with a first knurling and an outer wall of the waterproof rear cover is provided with a second knurling.

7. The spotlight structure according to claim 1, wherein, an oblique-opening cover is arranged on the waterproof front cover.

8. The spotlight structure according to claim 1, wherein, a cleaning device is arranged on an outer wall of the main body, and the cleaning device comprises:
a housing, wherein, the housing is arranged on the outer wall of the main body, and the housing is shaped as a cylinder; a side wall of the housing is provided with an annular opening;
a bearing, wherein, the bearing is arranged in the housing, and an inner ring of the bearing is fixed to the outer wall of the main body;
a first bevel gear, wherein, a first through hole is arranged at a center of the first bevel gear; an inner wall of the first through hole is fixedly connected to an outer ring of the bearing, and the first bevel gear is rotated around an axis of the main body;
a sliding groove, wherein, the sliding groove is arranged on a side wall of the first bevel gear; the sliding groove extends in a radial direction of the first bevel gear; a sliding block is arranged in the sliding groove, and the sliding block moves back and forth along the sliding groove; an engaged strip is arranged on a side wall of the sliding block; an inner wall of the sliding groove is provided with a guide groove, and the engaged strip is engaged into the guide groove;
a guide rod, wherein, the guide rod is arranged under the sliding groove; a first end of the guide rod is connected to the side wall of the first bevel gear, and a second end of the guide rod passes through the annular opening and the second end of the guide rod extends out of the housing;
a cleaning ring, wherein, the cleaning ring is arranged on the outer wall of the main body; a side wall of the cleaning ring is provided with a second through hole, and the second through hole extends in an axial direction of the cleaning ring; an end of the guide rod away from the first bevel gear passes through the second through hole and is connected to a stop block; a bristle is arranged on an inner wall of the cleaning ring;
a spring, wherein, the spring is sleeved on the guide rod; a first end of the spring is connected to the side wall of the first bevel gear, and a second end of the spring is connected to the cleaning ring; and
a connecting rod, wherein, a first end of the connecting rod is hinged to the sliding block, and a second end of the connecting rod is hinged to an outer wall of the cleaning ring.

9. The spotlight structure according to claim 8, wherein, the cleaning devices further comprises a motor, wherein, the motor is arranged on the outer wall of the main body; the motor is located in the housing; an output shaft of the motor extends outwards and is connected to a second bevel gear; the first bevel gear is engaged with the second bevel gear.

10. The spotlight structure according to claim 9, further comprising a cleaning solution spraying device, wherein, the cleaning solution spraying device comprises:
a fluid storage tank, wherein, the fluid storage tank is arranged at an upper end of the housing, and a cleaning solution is arranged in the fluid storage tank;
a plurality of third through holes, wherein, the plurality of third through holes are provided on the outer wall of the main body in a circumferential direction of the main body, and the cleaning ring covers on the plurality of third through holes;
a spray head, wherein, the spray head is arranged on the stop block, and a nozzle of the spray head faces toward the plurality of third through holes;
a connecting pipe, wherein, a first end of the connecting pipe is connected to a bottom of the fluid storage tank, and a second end of the connecting pipe is connected to the spray head; a pressure pump and a solenoid valve are successively arranged on the connecting pipe; a processor is arranged in the housing, and the processor is connected to the motor, the pressure pump and the solenoid valve; the processor is wirelessly communicated with a mobile terminal; and
a fluid intake pipe, wherein, the fluid intake pipe is arranged on a top of the fluid storage tank, and a cover is arranged on an upper end of the fluid intake pipe.
